(19) United States
(12) Patent Application Publication
(10) Pub. No.: US 2026/0344937 A1
(43) Pub. Date: Nov. 5, 2026

(54) SOFT CLOSE ASSEMBLY FOR A TILT-HEAD STAND MIXER

(71) Applicant: WHIRLPOOL CORPORATION, BENTON HARBOR, MI (US)

(72) Inventors: Joseph Snyder, St. Joseph, MI (US); Benjamin B. Edinger, Grand Haven, MI (US); Zachary D. Graves, Norton Shores, MI (US); Michael A. Johnson, West Olive, MI (US); Michael A. Stinchcomb, Grand Haven, MI (US)

(73) Assignee: WHIRLPOOL CORPORATION, BENTON HARBOR, MI (US)

(21) Appl. No.: 19/199,270

(22) Filed: May 5, 2025

(51) Int. Cl. A47J 43/044

(52) U.S. Cl. CPC A47J 43/044; A47J 2043/04481; A47J 2043/0449

(57) ABSTRACT

A soft close assembly for a stand mixer includes a base defining a cavity. A mixer head is pivotably mounted to the base and operable along an actuation path between an open position and a closed position. A biasing member is disposed in the cavity of the base. The biasing member impedes movement along the actuation path as the mixer head moves from the open position to the closed position. A damper is disposed in the cavity of the base proximate the biasing member. The damper dampens movement along the actuation path to lessen a rate of movement as the mixer head moves towards the closed position. A linkage operably couples the mixer head to the base. The linkage is configured to assist the mixer head in pivoting between the open position and the closed position.

### BACKGROUND OF THE DISCLOSURE

The present disclosure generally relates to a tilt-head stand mixer, and more specifically, to a soft close assembly for the tilt-head stand mixer.

### SUMMARY OF THE DISCLOSURE

According to one aspect of the present disclosure, a soft close assembly for a stand mixer includes a base defining a cavity. A mixer head is pivotably mounted to the base and operable along an actuation path between an open position and a closed position. A biasing member is disposed in the cavity of the base. The biasing member impedes movement along the actuation path as the mixer head moves from the open position to the closed position. A damper includes a piston rod disposed in the cavity of the base proximate the biasing member. The damper dampens movement along the actuation path to lessen a rate of movement as the mixer head moves towards the closed position. A linkage operably couples the mixer head to the base. The linkage is configured to assist the mixer head in pivoting between the open position and the closed position.

According to another aspect of the present disclosure, a stand mixer includes a base and a mixer head pivotably mounted to the base. The mixer head is operable along an actuation path between an open position and a closed position. A biasing member is operably coupled with the base and engaged along an entirety of the actuation path. A damper is operably coupled with the base and hinders movement along a portion of the actuation path of the mixer head as the mixer head moves toward the closed position. A plurality of linkages is positioned between the base and mixer head. The plurality of linkages are configured to pivotably couple the base to the mixer head to assist in moving the mixer head between the open position and the closed position.

According to yet another aspect of the present disclosure, an appliance for mixing food items includes a base pivotably coupled to a mixer head. The mixer head is operable along an actuation path between an open position and a closed position. A biasing member is operably coupled with the base and is configured to engage the mixer head along the actuation path to restrict a first rate of movement of the mixer head when transitioning from the open position to the closed position. A damper is positioned proximate the biasing member and is configured to provide a damping effect along the actuation path to restrict a second rate of movement of the mixer head as the mixer head transitions from the open position to the closed position.

According to another aspect of the present disclosure, a stand mixer includes a dual component soft close assembly that facilitates controlled and dampened movement of a mixer head along an actuation path between an open position and an operational or closed position. The dual component soft close assembly includes a biasing member, such as a coil spring and a coil rod, that impedes movement of the mixer head along the actuation path from the open position to restrict an initial rate of movement of the mixer head. A damper is positioned proximate the biasing member and provides a damping effect along the actuation path to further restrict or dampen the rate of movement as the mixer head approaches the closed position. This parallel cushioning and dampening action lessens jarring or sudden dropping of the relatively heavy mixer head. A plurality of linkages couple the mixer head to a base of the stand mixer and engage the biasing member and the damper to assist in the smooth pivoting action of the mixer head. Strategic positioning of the angled biasing engagement and damping initiation of the soft close assembly enhances controlled deceleration of the mixer head. The synergistic soft close assembly improves a user experience by preventing abrupt slamming while facilitating easy opening and closing.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a stand mixer having a base and a mixer head in an open position, according to one aspect of the present disclosure;

FIG. 2 is a side perspective view of a support stem of a stand mixer operably coupled to a mixer head, according to one aspect of the present disclosure;

FIG. 3 is a rear perspective partial cross-sectional view of a support stem of a stand mixer including a biasing member abutting a second link of a plurality of linkages and a damper in a retracted position within a damper cavity, according to one aspect of the present disclosure;

FIG. 4 is a rear perspective view of a portion of a plurality of linkages operably coupled to a support stem and a pivot shaft of a mixer head, according to one aspect of the present disclosure;

FIG. 5A is a side elevational partial cross-sectional view of a soft close assembly and a mixer head illustrated in an open position including a biasing member in a decompressed position and a damper in a retracted position with a transition position and closed position in phantom, according to the present disclosure;

FIG. 5B is a side elevational partial cross-sectional view of a soft close assembly and a mixer head illustrated transitioning between an open position and a closed position including a biasing member abutting a second link in a partially compressed position and a damper in an extended position with a closed position and open position in phantom, according to the present disclosure; and

FIG. 5C is a side elevational partial cross-sectional view of a soft close assembly and a mixer head illustrated in a closed position including a biasing member in a fully compressed position and a damper in a retracted position with a transition position and open position in phantom, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a soft close assembly for a tilt-head stand mixer. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

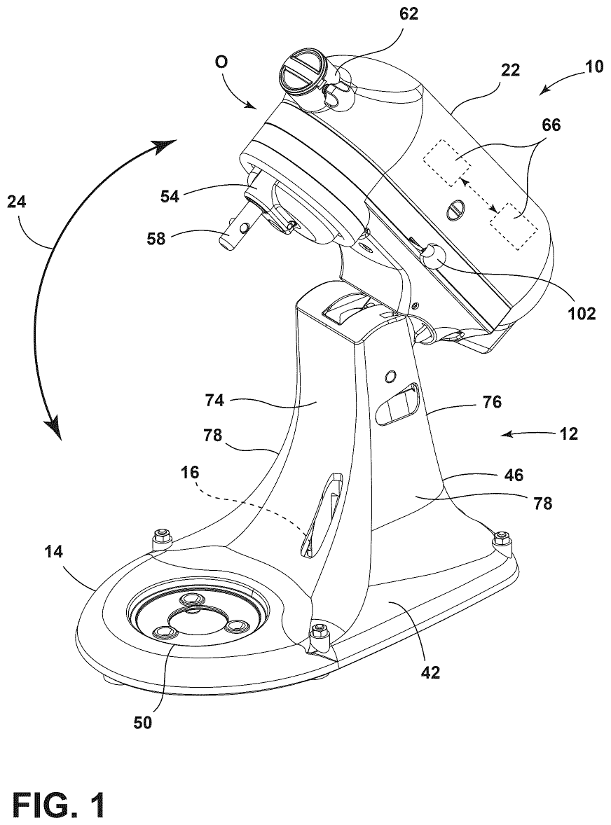

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

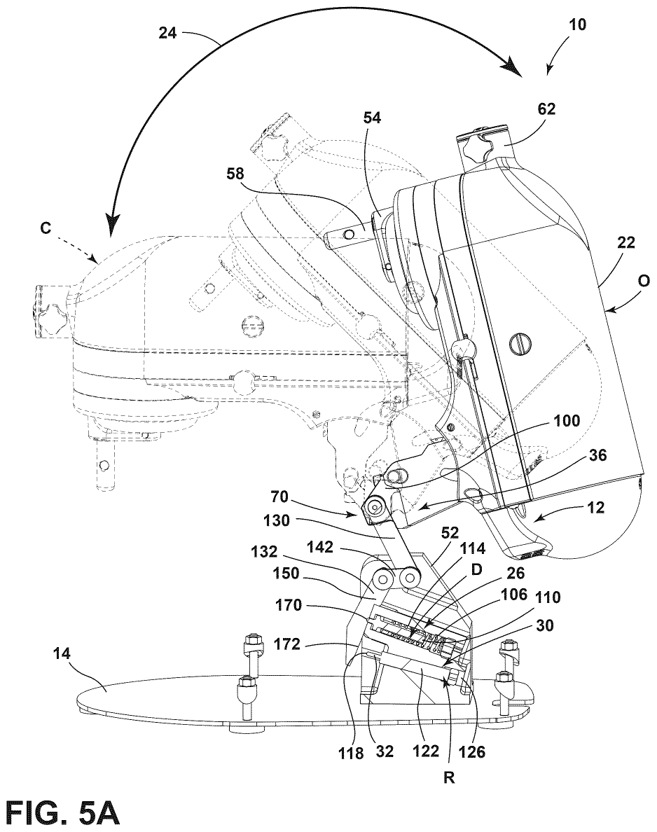

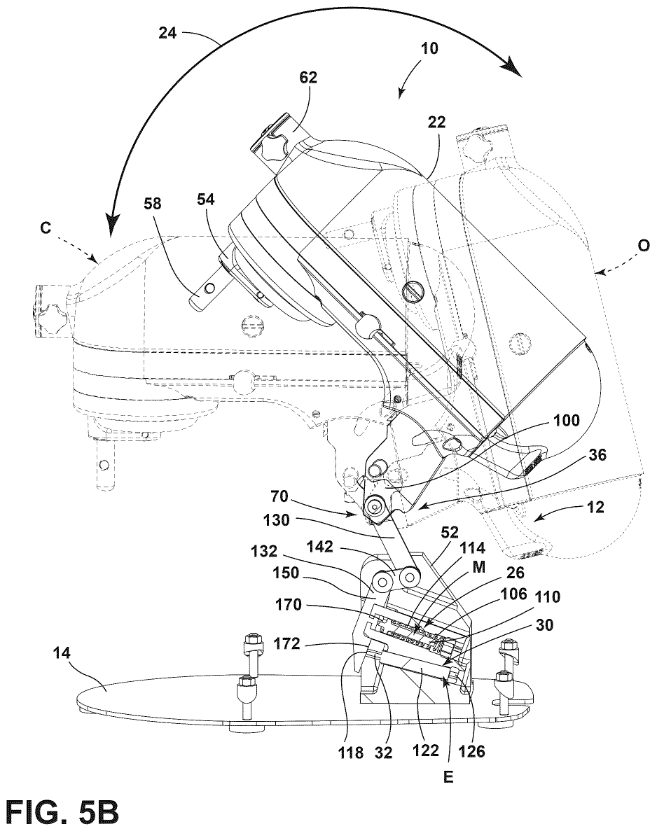

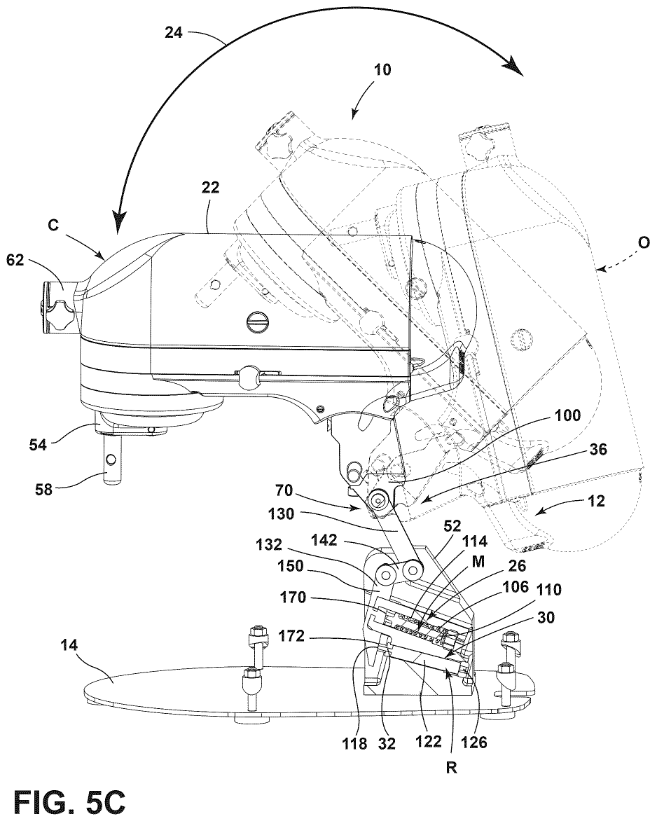

Referring to FIGS. 1-8, reference numeral 10 generally designates a countertop stand mixer appliance 10 (hereinafter “stand mixer”). A soft close assembly 12 for the stand mixer 10 generally includes a base 14 defining a cavity 16. A mixer head 22 is pivotably mounted to the base 14 and is operable along an actuation path 24 between a closed position C (FIG. 5C) and an open position O (FIG. 1). A biasing member 26 is disposed in the cavity 16 of the base 14. The biasing member 26 impedes movement along the actuation path 24 as the mixer head 22 moves from the open position O to the closed position C. A damper 30 including a piston rod 32 is disposed in the cavity 16 of the base 14 proximate the biasing member 26. The damper 30 dampens movement along the actuation path 24 to lessen a rate of movement as the mixer head 22 moves towards the closed position C. A plurality of linkages 36 operably couples the mixer head 22 to the base 14. The plurality of linkages 36 are configured to assist the mixer head 22 in pivoting between the open position O and the closed position C.

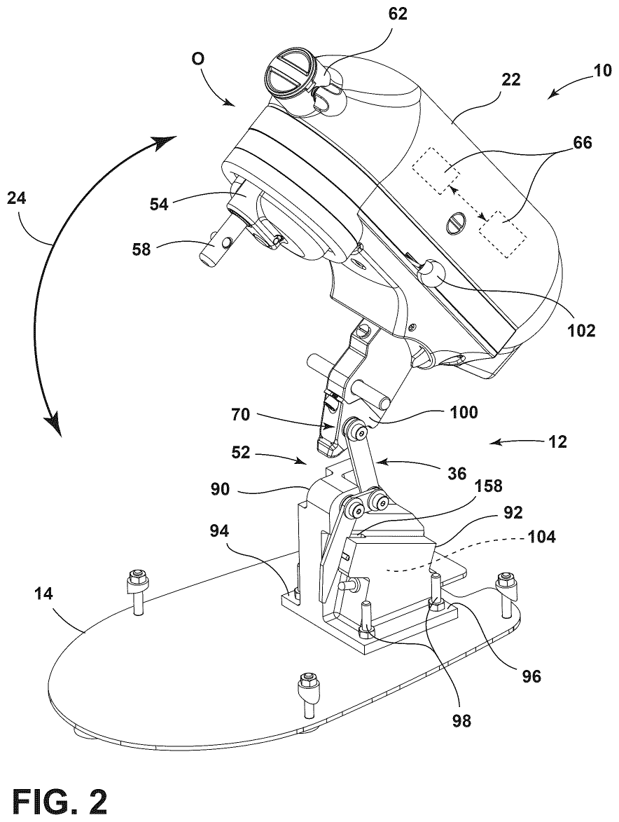

Referring to FIGS. 1 and 2, the base 14 of the stand mixer 10 generally includes an L-shaped pedestal 42, where the L-shaped pedestal 42 includes an upstanding support arm 46. The pedestal 42 is a weighted member, made from a cast metal material, such as die cast zinc, which supports the mixer head 22 in a pivoting manner. However, other materials may be contemplated. The pedestal 42 of the base 14 defines a landing 50 for supporting a mixing vessel, such as a mixing bowl. The base 14 includes a support stem 52 disposed within the upstanding support arm 46. The support stem 52 is configured to include components of the soft close assembly 12, as is further described herein. A primary drive assembly 54 operably coupled to the mixer head 22 includes a drive shaft 58 used to process ingredients or contents of the mixing vessel in the mixing procedure using any one of a variety of mixing tools adapted to couple to the drive shaft 58. A secondary drive coupling hub 62 operably coupled to the mixer head 22 is used for coupling and powering an accessory of the stand mixer 10. The primary drive assembly 54 and the secondary drive coupling hub 62 are powered by at least one motor 66 disposed within the stand mixer 10.

The stand mixer 10 is a tilt-head stand mixer 10, and as such, the mixer head 22 is an articulating mixer head configured to pivot between the operational or closed position C (FIG. 5C) and the open position O (FIG. 1) relative to the base 14 at pivot point 70 or along a pivot axis 72. In various examples, the stand mixer 10 or the mixer head 22 are referred to as being in the closed position C or the open position O. For example, the stand mixer 10 is in the open position O, when the mixer head 22 is rotated upward at an angle of between approximately 75° and approximately 90° relative to the base 14. Alternatively, the mixer head 22 is in the operational or closed position C, when the mixer head 22 is rotated downwards at an angle of approximately 0° and approximately 10° relative to and towards the base 14 ready for a mixing procedure. Additionally, as the mixer head 22 travels between the open position O and the closed position C, the mixer head 22 can be in a transitory or intermediary position such that the mixer head 22 is rotated upward or downward at an angle of about 11° and about 74°. However, it is contemplated that the mixer head 22 may be positioned at varying or differing angles along the actuation path 24.

Referring still to FIGS. 1 and 2, the pivot point 70 corresponds with a coupling of the base 14, specifically, of the pedestal 42 and the mixer head 22. The upstanding support arm 46 of the pedestal 42 includes a front wall 74, a rear wall 76, and opposing sidewalls 78a, 78b that define the cavity 16. The support stem 52 is disposed in the cavity 16 defined within the upstanding support arm 46 of the L-shaped pedestal 42. Accordingly, the support stem 52 includes an upper portion 90 defining a slot 158 that engages with the plurality of linkages 36, an intermediate portion 92 configured to house various components of the soft close assembly 12, such as the biasing member 26 and the damper 30, and a lower portion 94 defining a support stem base 96. The support stem base 96 is generally a square shape and includes apertures configured to receive fasteners 98 to position the support stem 52 firmly onto the base 14 of the stand mixer 10. However, it is contemplated that the support stem base 96 may be a variety of shapes. Additionally, as illustrated in FIG. 2, the upper and intermediate portions 90, 92 of the support stem 52 operably couple the plurality of linkages 36 to a pivot shaft 100 of the mixer head 22 to form the pivot point 70 that assists the mixer head 22 in moving to, from, and between the closed position C and the open position O about the pivot axis 72.

The mixer head 22 of the stand mixer 10 includes a user control 102 which is illustratively depicted in FIGS. 1 and 2 as a sliding speed control knob operably coupled to a side of the mixer head 22. The user may choose a desired speed setting with the control knob, and the control component of the at least one motor 66 will generally attempt to operate the motor 66 at the desired speed. It will be contemplated that in various examples, the user control 102 may be any type of analog or digital user interface operable to input a desired speed setting for the stand mixer 10. Additionally, a lock mechanism is disposed on an opposing side of the mixer head 22 relative to the speed control knob. The lock mechanism is configured to lock the mixer head 22 in the closed position C.

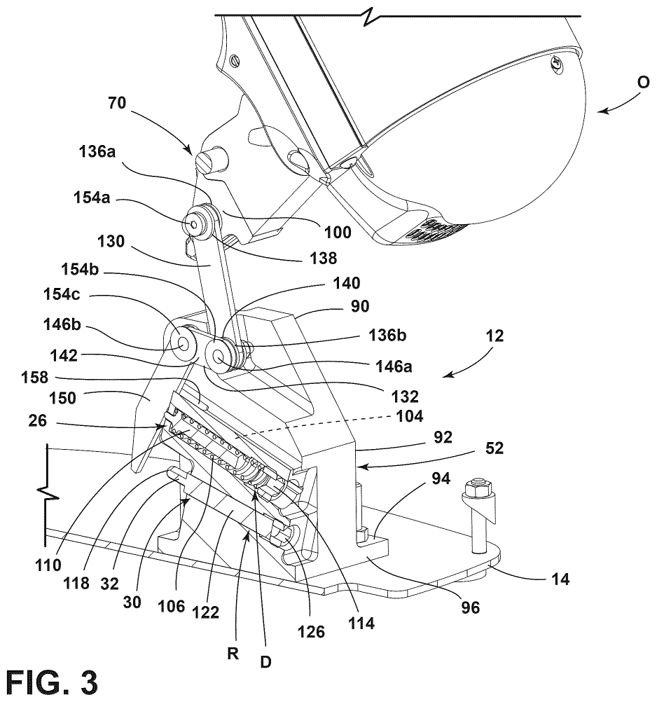

Referring still to FIGS. 1 and 2, as well as FIG. 3, the mixer head 22 is a generally heavy component of the stand mixer 10 with a center of gravity positioned along a rear end of the mixer head 22 proximate the upstanding support arm 46 of the base 14 when in the open position O. The center of gravity is adjusted along a forward end of the mixer head 22 towards the user control 102 and secondary drive coupling hub 62, as the mixer head 22 moves to the closed position C. The adjustment of the center of gravity from the rear end of the mixer head 22 to a forward end facilitates movement from the open position O to the closed position C in a sudden and jarring manner if not sufficiently controlled by the user. Accordingly, the soft close assembly 12 of the stand mixer 10, described herein, assists in controlling the actuation path 24 of the mixer head 22 to reduce a sudden dropping motion or jarring effect of the stand mixer 10.

Referring still to FIGS. 2 and 3, the soft close assembly 12 includes the biasing member 26 disposed in an interior 104 of the support stem 52. The biasing member 26 includes a coil spring 106 and a coil rod 110 disposed within a receiving cavity 114 defined by the intermediate portion 92 of the support stem 52. However, it is contemplated that the biasing member 26 may be a leaf spring, compression spring, extension spring, torsion spring, gas spring, elastomeric spring, or other similar biasing mechanisms. The biasing member 26 is operable between a compressed position M and a decompressed position D as the mixer head 22 moves between the open position O and the closed position C. In some implementations, the biasing member 26 is a length between about 50 mm to about 60 mm including a spring rate between about 0.5 lbs/mm to about 3 lbs/mm and a maximum load capability of between approximately 25 lbs to about 45 lbs. However, it is contemplated that the length, spring rate, and maximum load capability of the biasing member 26 may vary based on desired usage. The biasing member 26 is disposed in the interior 104 of the support stem 52 positioned within the receiving cavity 114 and engages the plurality of linkages 36 of the stand mixer 10, when in the compressed position M. Accordingly, the biasing member 26 is configured to impede the downward movement or downward motion of the mixer head 22 from the open position O to the closed position C along the actuation path 24 to lessen a first rate of movement of the mixer head 22.

The biasing member 26 may also be positioned between the mixer head 22 and the pedestal 42 in another manner, so long as the biasing member 26 is positioned in a manner to reduce the downward movement of the mixer head 22 relative to the pedestal 42. The biasing member 26 is configured so that it does not interfere with the upward opening movement of the mixer head 22 from the closed position C to the open position O along the actuation path 24. Additionally, the biasing member 26 is configured to impart a selective impeded downward movement of the mixer head 22, so as to limit the footprint of the biasing member 26 to the user.

Referring still to FIGS. 2 and 3, the soft close assembly 12 includes the damper 30 that is configured to assist in further reducing the mixer head 22 from producing a sudden or jarring movement of the stand mixer 10 when transitioning from the open position O to the closed position C. The damper 30 includes the piston rod 32 having a head portion 118 encompassed by a damper housing 122. The damper 30 is disposed in the interior 104 of the support stem 52 and is positioned proximate the biasing member 26. In particular, the piston rod 32 and the head portion 118 are received by the damper housing 122. The damper housing 122 is slidably received by a damper cavity 126 defined by the support stem 52. The damper 30 is operable between an extended position E and a retracted position R and is configured to engage the plurality of linkages 36 when in use to dampen the movement of the mixer head 22. Accordingly, when the damper 30 operates between the extended position E and the retracted position R when the mixer head 22 travels along the actuation path 24, the damper 30 lessens a second rate of movement of the mixer head 22 traveling from the open position O to the closed position C.

The biasing member 26 is vertically displaced from the damper 30, where the biasing member 26 is positioned higher than the damper 30. However, it is contemplated that the damper 30 may be vertically displaced from the biasing member 26 such that the biasing member 26 may be positioned lower than the damper 30. Additionally, in some implementations, the damper 30 includes a load handling capability of between about 3 kg to about 7 kg, a damper housing 122 length of between about 45 mm to about 55 mm, and a stroke length of the piston rod 32 between about 7 mm to about 18 mm. However, it is contemplated that the load handling capability of the damper 30, the length of the damper housing 122, and the stroke length of the piston rod 32 may vary based on desired usage. Accordingly, the damper 30 is a biased member, such that the piston rod 32 and the head portion 118 are biased outwardly towards the extended position E by hydraulic means, or other biasing mechanisms. In some implementations, the damper 30 may be described as a hydraulic piston damper providing a controlled damping of the mixer head 22 towards the closed position C along the actuation path 24 of the mixer head 22. However, it is contemplated that the damper 30 may be a pneumatic damper, shock absorber, linear damper, rotary damper, and other similar dampening mechanisms.

Referring still to FIGS. 2 and 3, the damper 30 is configured to dampen the downward movement or downward motion of the mixer head 22 from the open position O to the closed position C along the actuation path 24. The damper 30 may be positioned between the mixer head 22 and the pedestal 42 in another manner, so long as the damper 30 is suitably positioned to dampen the downward movement of the mixer head 22 relative to the pedestal 42. The damper 30 is configured so that it does not interfere with the upward opening movement of the mixer head 22 from the closed position C to the open position O along the actuation path 24. Further, the damper 30 is configured to impart a selective dampening effect on the downward movement of the mixer head 22, so as to further limit the footprint of the biasing member 26 and the damper 30 to the user. Accordingly, the dampening effect of the damper 30 further assists in lessening the second rate of movement of the mixer head 22 in conjunction with the biasing member 26 as the mixer head 22 moves towards the closed position C.

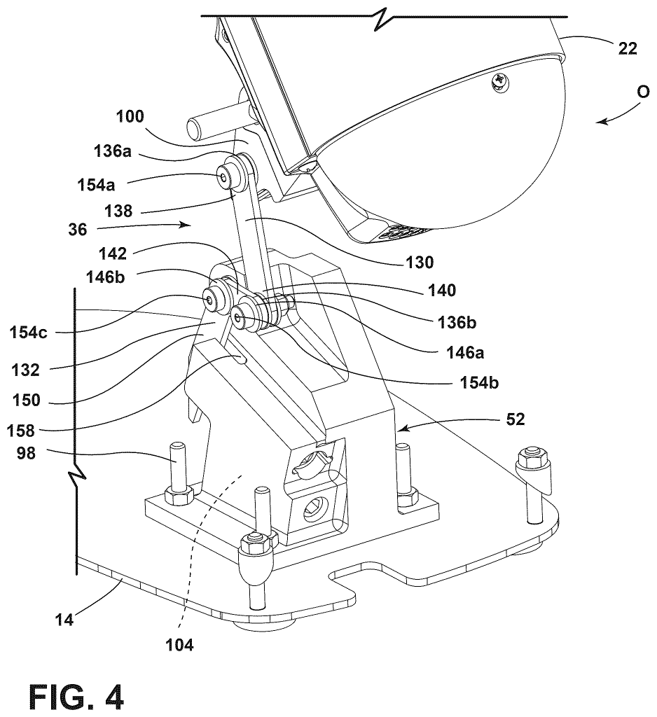

Referring still to FIG. 3, as well as FIG. 4, the soft close assembly 12 of the stand mixer 10 includes the plurality of linkages 36 operably coupling the support stem 52 and the mixer head 22. The plurality of linkages 36 includes a first link 130 operably coupled to a second link 132. The first link 130 is a generally elongated member defining an aperture 136a at a first end 138 and an aperture 136b at a second end 140. The second link 132 includes a first portion 142 that defines opposing apertures 146a, 146b, and a second portion 150 which is generally a free end of the second link 132 that extends downward towards the base 14 of the stand mixer 10. Accordingly, aperture 136a of the first link 130 is operably coupled to the pivot shaft 100 of the mixer head 22 via a fastener 154a to form the pivot point 70 at which the mixer head 22 pivots between the open position O to the closed position C along the pivot axis 72.

Aperture 136b of the first link 130 aligns with aperture 146a of the first portion 142 of the second link 132 to receive the fastener 154b. Aperture 146b of the second link 132 aligns with an opening defined by the upper portion 90 of the support stem 52 to receive a fastener 154c to assist in operably coupling the second link 132 to the support stem 52. In some implementations, the first link 130 and the second link 132 pivot relative to each other about fastener 154b. For example, the operable coupling of the first link 130 to the first portion 142 of the second link 132 between the mixer head 22 and the base 14 facilitates the pivoting movement of the mixer head 22 between the closed position C and the open position O. Additionally, the second link 132 is configured to be received by the slot 158 defined by the support stem 52 to assist in moving the mixer head 22 between the open and closed positions O, C. However, it is contemplated that the first link 130 and the second link 132 may rotate independent of one another or may remain fixed as the mixer head 22 travels along the actuation path 24.

Referring now to the illustrated configuration depicted in FIG. 5A, the mixer head 22 is shown in a fully open position O at an angle between about 75° and about 80° relative to the base 14. However, it is contemplated that the mixer head 22 may be positioned at an angle between about 75° and about 90° or may extend beyond 90° when in the open position O. Additionally, as illustrated in FIG. 5A, the support stem 52 is shown in a cross-sectional view including the biasing member 26 and the damper 30 disposed therein. When the mixer head 22 is in the open position O, the coil rod 110 of the biasing member 26 abuts, or is in contact with, the upper edge 170 of the second portion 150 of the second link 132 imparting an initial, nominal biasing force on the mixer head 22. Accordingly, the biasing member is in a nominally compressed position M. Alternatively, it is contemplated that when the mixer head 22 is in the open position O, the biasing member 26 may not be in contact or may not abut the second link 132, leaving the biasing member 26 unaffected and in a fully decompressed position D having no effect on the mixer head 22.

Referring still to FIG. 5A, when the mixer head 22 is in the open position O, the damper 30 is in a fully retracted position R. The piston rod 32 and the head portion 118 of the damper 30 are disposed within the damper housing 122. The damper 30 is positioned within the damper cavity 126 of the support stem 52. The head portion 118 of the damper 30 is spaced apart from the lower edge 172 of the second link 132 when in the retracted position R. Accordingly the damper 30 has no effect on the mixer head 22 when in the open position O. Additionally, as the mixer head 22 begins to move along the actuation path 24, the damper housing 122 is configured to contain the biasing means, such as hydraulic fluid, and receives the piston rod 32 as the damper 30 moves between the retracted and extended position E, as is further described herein.

Referring now to the illustrated configuration depicted in FIG. 5B, as the mixer head 22 begins to move along the actuation path 24, the mixer head 22 is in a transitory or intermediary state between the open position O and the closed position C. As the mixer head 22 continues to travel from the open position O to the closed position C, the mixer head 22 is positioned at an angle between about 11° and about 74° relative to the base 14 along the actuation path 24. Accordingly, when in the transitory or intermediary state, the pivot shaft 100 of the mixer head 22 rotates or pivots about the axis 72. As the mixer head 22 begins to travel along the actuation path 24 at an angle of between about 75° and about 45° relative to the base 14 towards the closed position C, the coil rod 110 of the biasing member 26 remains in contact with the second link 132. As the second link 132 travels inwardly into the slot 158 towards the rear wall 76 the biasing member is placed in the compressed position M. When in the compressed position M, the coil spring 106 of the biasing member 26 is compressed or contracted to impart a selective biasing force on the mixer head 22 between about 0.5 lbs/mm to about 3 lbs/mm. However, it is contemplated that the biasing force imparted by the biasing member 26 may vary depending on usage. Accordingly, the biasing member 26 slows the first rate of movement of the mixer head 22 along the actuation path 24 towards the closed position C.

Referring still to the illustrated configuration depicted in FIG. 5B, as the mixer head 22 continues to move along the actuation path 24 towards the closed position C at an angle of between about 45° and about 0° relative to the base 14, the damper 30 is placed in the extended position E. Accordingly, the head portion 118 of the damper 30 contacts the lower edge 172 of the second link 132 and remains in contact with the lower edge 172 as the second link 132 continues to travel inwardly into the slot 158 towards the rear wall 76. The initial contact is shown as an abutting contact, similar to that of the coil rod 110, between the head portion 118 of the piston rod 32 and the lower edge 172 of the second link 132. When in the extended position E, the damper 30 begins to dampen the downward movement of the mixer head 22 towards the closed position C, in parallel with the continued impeded movement of the mixer head 22 by the biasing member 26 as the biasing member 26 is in the compressed position M. Accordingly, the damper 30 slows the second rate of movement of the mixer head 22 along the actuation path 24 towards the closed position C. Alternatively, it is contemplated that the second link 132 may remain fixed as the mixer head 22 continues to travel along the actuation path 24. Accordingly, the biasing member 26 and the damper 30 may interact, or make contact, with the upper edge 170 and the lower edge 172, respectively, of the second link 132 to assist in slowing the rate of movement of the mixer head 22 as it travels towards the closed position C.

Referring now to the illustrated configuration depicted in FIG. 5C, the mixer head 22 is shown in the closed position C at an angle of between about 0° to about 10° relative to the base 14. The biasing member 26 is shown in the fully compressed position M and the damper 30 is shown in the retracted position R. As the mixer head 22 travels along the actuation path 24 from the open position O through the transitory or intermediary position towards the closed position C, the movement of the mixer head 22 is progressively cushioned via the biasing member 26 and the damper 30, respectively. In particular, as the mixer head 22 reaches the closed position C, the biasing member 26 is in the fully compressed position M. Additionally, the piston rod 32 is axially moved within the damper housing 122 from the extended position E to the retracted position R to provide the dampening effect on the movement of the mixer head 22 along the actuation path 24. Accordingly, the soft close assembly 12 including the plurality of linkages 36 lessens the first rate of movement of the mixer head 22 from the open position O to the closed position C via the biasing member 26 and the second rate of movement of the mixer head 22 via the damper 30. As such, the biasing member 26 and the damper 30 impart a maximum slowing force on the mixer head 22 to assist in reducing sudden or jarring movements of the mixer head 22 when traveling to the closed position C.

Use of the present assembly may provide for a variety of advantages. For example, the soft close assembly 12 including the combination of the biasing member 26 and the damper 30 may help to reduce sudden or jarring movement of the mixer head 22 when transitioning from the open position O to the closed position C. The biasing member 26 may impede the first rate of movement of the mixer head 22 as the mixer head 22 travels along the actuation path 24 from the open position O to the closed position C, providing initial cushioning. The damper 30 may then dampen the second rate of movement of the mixer head 22 travels along the actuation path 24, further lessening the movement of the mixer head 22 as the mixer head 22 approaches the closed position C. This controlled, slowed movement of the mixer head 22 prevents the relatively heavy mixer head 22 from abruptly dropping downward toward the base 14 and causing potential damage to the appliance. The soft close assembly 12 allows for the smooth, controlled closing action of the mixer head 22, enhancing the user experience and product durability. Additionally, the parallel action of the biasing member 26 and damper 30 in dampening the movement of the mixer head 22 via the plurality of linkage 36 provides redundancy and a more robust dampening effect.

According to one aspect of the present disclosure, a soft close assembly for a stand mixer includes a base defining a cavity. A mixer head is pivotably mounted to the base and operable along an actuation path between an open position and a closed position. A biasing member is disposed in the cavity of the base. The biasing member impedes movement along the actuation path as the mixer head moves from the open position to the closed position. A damper including a piston rod is disposed in the cavity of the base proximate to the biasing member. The damper dampens movement along the actuation path to lessen a rate of movement as the mixer head moves towards the closed position. A linkage operably couples the mixer head to the base, where the linkage is configured to assist the mixer head in pivoting between the open position and the closed position.

According to another aspect, a support stem is disposed within a cavity of a base, where the support stem defines a receiving cavity configured to receive a biasing member and a damper cavity configured to receive a damper.

According to yet another aspect, a biasing member includes a coil spring and a coil rod disposed within a receiving cavity defined by a support stem.

According to another aspect, a coil spring and a coil rod of a biasing member engage with a linkage to contract along an actuation path as a mixer head moves from an open position to a closed position.

According to another aspect, where a piston rod of a damper includes a head portion, where the damper includes a damper housing encompassing the piston rod.

According to another aspect, a piston rod of a damper is axially movable within a damper housing between a retracted position and an extended position and is biased towards the extended position when a mixer head moves from an open position to a closed position.

According to another aspect, a piston rod is axially movable within a damper housing when a damper engages with a linkage in a retracted position along an actuation path as a mixer head moves towards a closed position.

According to another aspect, a mixer head includes a pivot shaft operably coupled to the base, wherein the pivot shaft forms a pivot axis configured to assist the mixer head in pivoting between an open position and a closed position.

According to another aspect, a biasing member impedes movement of a mixer head when the mixer head is at a first angle moving along an actuation path towards the closed position.

According to another aspect, a damper dampens movement of a mixer head when the mixer head is at a second angle moving along an actuation path towards the closed position.

According to yet another aspect, a stand mixer includes a base. A mixer head is pivotably mounted to the base and operable along an actuation path between an open position and a closed position. A biasing member operably coupled with the base and engaged along an entirety of the actuation path. A damper operably coupled with the base. The damper hinders movement along a portion of the actuation path of the mixer head as the mixer head moves toward the closed position. A plurality of linkages is positioned between the base and mixer head. The plurality of linkages are configured to pivotably couple the base to the mixer head to assist in moving the mixer head between the open position and the closed position.

According to another aspect, a first link of a plurality of linkages includes a first end and a second end, and a second link of the plurality of linkages includes a first portion and a second portion, where the second end of the first link is operably coupled to the first portion of the second link.

According to another aspect, a mixer head includes a pivot shaft rotatable about a pivot axis, where a first end of a first link is pivotably coupled to the pivot shaft to assist a mixer head in pivoting about the pivot axis between an open position and a closed position.

According to another aspect, a second portion of a second link moves towards a biasing member and a damper along an entirety of an actuation path as a mixer head moves to a closed position.

According to another aspect, a second portion of a second link defines an upper edge proximate to a biasing member and a lower edge proximate a damper.

According to another aspect, a biasing member includes a coil rod encompassed by a coil spring, where the coil rod and the coil spring abut an upper edge of a second portion of a second link to impede movement of a mixer head along an entirety of an actuation path.

According to another aspect, a damper includes a piston rod having a head portion, where the head portion of the piston rod abuts a lower edge of a second portion along a portion of an actuation path to lessen a rate of movement of a mixer head.

According to another aspect, an appliance for mixing food items includes a base pivotably coupled to a mixer head. The mixer head is operable along an actuation path between an open position and a closed position. A biasing member operably coupled with the base and configured to engage the mixer head along the actuation path to restrict a first rate of movement of the mixer head when transitioning from the open position to the closed position. A damper positioned proximate the biasing member and configured to provide a damping effect along the actuation path to restrict a second rate of movement of the mixer head as the mixer head transitions from the open position to the closed position.

According to another aspect, a damper includes a piston rod and a damper housing, where the piston rod is axially movable within the damper housing between an extended position and a retracted position and is biased towards the extended position to provide a damping effect along an actuation path of a mixer head.

According to another aspect, a biasing member includes a coil spring and a coil rod disposed in a receiving cavity of a base, where the coil spring and the coil rod are axially movable within the receiving cavity between a compressed position and a decompressed position and are biased towards the compressed position to impede movement of a mixer head along an actuation path.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A soft close assembly for a stand mixer, comprising:
a base defining a cavity;
a mixer head pivotably mounted to the base and operable along an actuation path between an open position and a closed position;
a biasing member disposed in the cavity of the base, wherein the biasing member impedes movement along the actuation path as the mixer head moves from the open position to the closed position;
a damper disposed in the cavity of the base proximate the biasing member, wherein the damper dampens movement along the actuation path to lessen a rate of movement as the mixer head moves towards the closed position; and
a linkage operably coupling the mixer head to the base, wherein the linkage is configured to assist the mixer head in pivoting between the open position and the closed position.

2. The soft close assembly of claim 1, further comprising:
a support stem disposed within the cavity of the base, wherein the support stem defines a receiving cavity configured to receive the biasing member and a damper cavity configured to receive the damper.

3. The soft close assembly of claim 2, wherein the biasing member includes a coil spring and a coil rod disposed within the receiving cavity defined by the support stem.

4. The soft close assembly of claim 3, wherein the coil spring and the coil rod of the biasing member engage with the linkage to contract along the actuation path as the mixer head moves from the open position to the closed position.

5. The soft close assembly of claim 1, wherein the damper includes a piston rod having a head portion, and wherein the damper includes a damper housing encompassing the piston rod.

6. The soft close assembly of claim 5, wherein the piston rod of the damper is axially movable within the damper housing between a retracted position and an extended position and is biased towards the extended position when the mixer head moves from the open position to the closed position.

7. The soft close assembly of claim 6, wherein the piston rod is axially movable within the damper housing when the damper engages with the linkage when in the retracted position along the actuation path as the mixer head moves towards the closed position.

8. The soft close assembly of claim 1, wherein the mixer head includes a pivot shaft operably coupled to the linkage, wherein the pivot shaft forms a pivot axis configured to assist the mixer head in pivoting between the open position and the closed position.

9. The soft close assembly of claim 1, wherein the biasing member impedes movement of the mixer head when the mixer head is at a first angle moving along the actuation path towards the closed position.

10. The soft close assembly of claim 1, wherein the damper dampens movement of the mixer head when the mixer head is at a second angle moving along the actuation path towards the closed position.

11. A stand mixer, comprising:
a base;
a mixer head pivotably mounted to the base and operable along an actuation path between an open position and a closed position;
a biasing member operably coupled with the base and engaged along an entirety of the actuation path;
a damper operably coupled with the base, wherein the damper hinders movement along a portion of the actuation path of the mixer head as the mixer head moves towards the closed position; and
a plurality of linkages positioned between the base and the mixer head, wherein the plurality of linkages are configured to pivotably couple the base to the mixer head to assist in moving the mixer head between the open position and the closed position.

12. The stand mixer of claim 11, further comprising:
a first link of the plurality of linkages having a first end and a second end; and
a second link of the plurality of linkages including a first portion and a second portion, wherein the second end of the first link is operably coupled to the first portion of the second link.

13. The stand mixer of claim 12, wherein the mixer head includes a pivot shaft rotatable about a pivot axis, and wherein the first end of the first link is pivotably coupled to the pivot shaft to assist the mixer head in pivoting about the pivot axis between the open position and the closed position.

14. The stand mixer of claim 12, wherein the second portion of the second link moves towards the biasing member and the damper along the entirety of the actuation path as the mixer head moves to the closed position.

15. The stand mixer of claim 12, wherein the second portion of the second link defines an upper edge positioned proximate the biasing member and a lower edge positioned proximate the damper as the mixer head moves towards the closed position.

16. The stand mixer of claim 15, wherein the biasing member includes a coil rod encompassed by a coil spring, and wherein the coil rod and the coil spring abut the upper edge of the second portion of the second link to impede movement of the mixer head along the entirety of the actuation path.

17. The stand mixer of claim 15, wherein the damper includes a piston rod having a head portion, and wherein the head portion of the piston rod abuts the lower edge of the second portion along the actuation path to hinder movement of the mixer head.

18. An appliance for mixing food items, comprising:
a base pivotably coupled to a mixer head, wherein the mixer head is operable along an actuation path between an open position and a closed position;
a biasing member operably coupled to the base and configured to engage the mixer head along the actuation path to restrict a first rate of movement of the mixer head when transitioning from the open position to the closed position; and
a damper positioned proximate the biasing member and configured to provide a damping effect along the actuation path to restrict a second rate of movement of the mixer head as the mixer head transitions from the open position to the closed position.

19. The appliance of claim 18, wherein the damper includes a piston rod and a damper housing, and wherein the piston rod is axially movable within the damper housing between an extended position and a retracted position and is biased towards the extended position to provide the damping effect along the actuation path of the mixer head.

20. The appliance of claim 18, wherein the biasing member includes a coil spring and a coil rod disposed in a receiving cavity of the base, and wherein the coil spring and the coil rod are axially movable within the receiving cavity between a compressed position and a decompressed position and are biased towards the compressed position to impede movement of the mixer head along the actuation path.
